(19) United States
(12) Patent Application Publication
(10) Pub. No.: US 2026/0158785 A1
(43) Pub. Date: Jun. 11, 2026

(54) LIQUID EJECTION HEAD AND PROCESS FOR PRODUCING LIQUID EJECTION HEAD

(71) Applicant: CANON KABUSHIKI KAISHA, Tokyo (JP)

(72) Inventors: HIROKI TAJIMA, Kanagawa (JP); ISAMU YONEDA, Kanagawa (JP); TAKEHO MIYASHITA, Kanagawa (JP)

(21) Appl. No.: 19/410,703

(22) Filed: Dec. 5, 2025

(30) Foreign Application Priority Data
Dec. 6, 2024 (JP) 2024-213839

(51) Int. Cl. B41J 2/16; B41J 2/14; B41J 2/175; B41J 2/18

(52) U.S. Cl. CPC B41J 2/1623; B41J 2/14; B41J 2/17596; B41J 2/18; B41J 2002/14491; B41J 2202/12; B41J 2202/13; B41J 2202/22

(57) ABSTRACT

A liquid ejection head of the present disclosure is a liquid ejection head including: a housing member including a liquid ejection module which ejects a liquid and a channel for supplying the liquid to the liquid ejection module; a wiring substrate including, at a first surface, a contact pad for electrically connecting to a liquid ejection apparatus; a first fixing portion at which the wiring substrate and the housing member are mechanically fixed to each other; and a second fixing portion which is provided between a second surface of the wiring substrate located on an opposite side from the first surface and a bonding surface provided on the housing member and at which the second surface and the bonding surface are fixed to each other with an adhesive agent.

### BACKGROUND

### Field of the Technology

The present disclosure relates to a liquid ejection head and a process for producing a liquid ejection head.

### Description of the Relatrd art

Liquid ejection heads have a wiring substrate for receiving electric signals from a liquid ejection apparatus. In such a liquid ejection head, the wiring substrate is fixed to a housing member.

The wiring substrate relays driving signals and driving power from the liquid ejection apparatus to the liquid ejection head. The liquid ejection apparatus' terminals are densely disposed on the wiring substrate, and it is difficult to wire them in a single layer. For this reason, a wiring substrate with a two-layer structure having two surfaces formed by a combination of a first layer for the driving signals and a second layer for the driving power is often used. The double-sided wiring substrate thus used tends to be light in weight, and is sufficiently fixed to the housing member. Also, even if the wiring substrate receives a pressure from its back surface, the deformation of the wiring substrate is minimized, so that reliability of the fixed portion is ensured.

For example, the head cartridge disclosed in Japanese Patent Laid-Open No. 2004-358912 (referred to as "Document 1" herein) has a structure in which the back surface of a wiring substrate fixed to a housing member is electrically connected to ink tanks. Document 1 discloses a structure for preventing or reducing bulging of a wiring substrate toward its front surface by a pressure from ink tanks in a head cartridge with a structure as above.

### SUMMARY

In the field of inkjet printers in recent years, the thickness and size of wiring substrates have increased, and there is a demand to improve the fixing between these wiring substrates and their housing members.

The present disclosure relates to a liquid ejection head including at least a housing member and a wiring substrate. The housing member of a liquid ejection head of the present disclosure includes a liquid ejection module and a channel for supplying a liquid to the liquid ejection module, the wiring substrate includes a contact pad at a first surface, and the liquid ejection head includes a first fixing portion at which the wiring substrate and the housing member are mechanically fixed to each other, and a second fixing portion at which a second surface of the wiring substrate located on an opposite side from the first surface and a bonding surface provided on the housing member are fixed to each other with an adhesive agent.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view of a liquid ejection apparatus;

FIG. 2 is a perspective view of a liquid ejection head;

FIG. 3 is an exploded perspective view of the liquid ejection head;

FIGS. 4A and 4B are schematic views illustrating how a wiring substrate is fixed to a housing member;

FIGS. 5A to 5C are schematic views illustrating cross sections of the wiring substrate and mounted components;

FIGS. 6A and 6B are schematic views illustrating the state of rivet portions of a conventional liquid ejection head in a case where it is dropped;

FIG. 7A is a perspective view illustrating the state of the liquid ejection head of the present disclosure before the wiring substrate is fixed;

FIG. 7B is an enlarged view of a portion described as 7B in FIG. 7A;

FIGS. 8A and 8B are schematic views illustrating the state of rivet portions of the liquid ejection head of the present disclosure in a case where it is dropped;

FIG. 9 is a flowchart of a process for producing a liquid ejection head including a procedure for assembling a wiring substrate to a housing member;

FIG. 10 is a schematic view illustrating a contact surface and bonding surface of the wiring substrate;

FIGS. 11A to 11C are schematic views illustrating variations of the shape of the bonding surface; and

FIG. 12 is a graph illustrating the result of a simulation on a stress exerted on the base of each rivet pin.

### DESCRIPTION OF THE EMBODIMENTS

In liquid ejection heads, a wiring substrate is fixed to a housing member only by heat riveting, and the wiring substrate is fixed to the housing member at four points substantially at four corners of the housing member. While there are liquid ejection heads in which a wiring substrate is fixed to a housing member with screws, a fixing method such as heat riveting or snap fitting is desirable from the perspective of the costs for the management of components, the management of processes, and the like.

Wiring substrates establish an electrical connection through contact between terminals (pins) on a liquid ejection apparatus and terminals (pads) on the liquid ejection head. Thus, the terminals are densely disposed, and it is difficult to wire them in a single layer. For this reason, a wiring substrate with a two-layer structure having two surfaces formed by a combination of a first layer for driving signals and a second layer for driving power is often used. The double-sided wiring substrate used in this case tends to be light in weight, and only requires heat riveting to be fixed to the housing member. Also, even if the wiring substrate receives a pressure from its back surface, the deformation of the wiring substrate is minimized, so that reliability is ensured for the rivet portions.

For example, the head cartridge in Document 1 represents a structure for preventing or reducing bulging of the wiring substrate toward its front surface by a pressure from the ink tanks. This structure minimizes bulging of the wiring substrate toward its front surface by arranging electric connection portions on straight lines each connecting rivet portions at opposite ends or within a region defined by rivet portions at four corners.

In the field of inkjet printers in recent years, the thickness of wiring substrates has increased, and their size has increased as well. Accordingly, the weight of the wiring substrates has increased. There is a possibility that, if a liquid ejection head having such a wiring substrate is dropped with the wiring substrate facing down, tip portions of the rivet portions fixing the wiring substrate may crack and the wiring substrate may get detached. A liquid ejection head of the present disclosure is directed to improving the fixing between its wiring substrate and housing member.

Embodiments of the liquid ejection head of the present disclosure will be described below with reference to the drawings. The embodiments to be described below are intended to illustrating examples of the present disclosure and not to limit the scope of the present disclosure to the illustrated examples. Unless otherwise specified, the dimensions, shapes, numbers, materials, and the like of various members in the following embodiments can be changes as appropriate within the scope of the present disclosure.

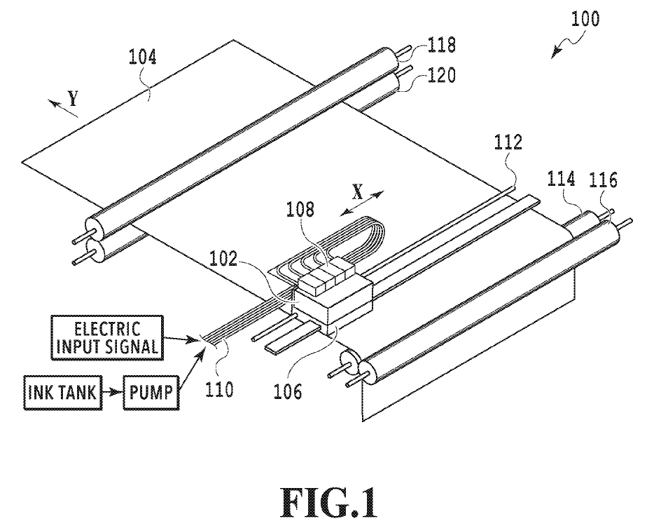

FIG. 1 is a schematic view of a liquid ejection apparatus 100 capable of utilizing the liquid ejection head of the present disclosure. The liquid ejection apparatus 100 is a serial scan-type inkjet printing apparatus. This printing apparatus is a type that has a liquid ejection head 102 and prints images onto a print medium 104 by ejecting inks from the liquid ejection head 102. The liquid ejection apparatus 100 is provided with ink tanks and pumps as ink supply sources, and inks stored in the ink tanks are supplied to circulation units through ink supply tubes by driving forces from the pumps. The liquid ejection head 102 is mounted on a carriage 106. The liquid ejection head 102 includes a sub tank unit 108. The sub tank unit 108 is connected to the ink tanks and supplied with inks. Electric wirings and ink and air pipes necessary for printing are provided to the carriage 106 along guides 110. The carriage 106 reciprocally moves along a guide shaft 112 in a main scanning direction along the arrow X. The print medium 104 is conveyed by conveyance rollers 114, 116, 118, and 120 in a sub scanning direction along the arrow Y crossing (in this embodiment, orthogonally crossing) the main scanning direction.

The liquid ejection head 102 is capable of performing high-quality full-color printing with multiple color inks. In the liquid ejection apparatus 100, a cap member (not illustrated) is disposed at a position outside the conveyance path for the print medium 104. While the liquid ejection apparatus is not performing a printing operation, this cap member makes a relative movement to a position at which it covers the orifice face of the liquid ejection head 102 and performs a suction operation to, for example, prevent drying of or recover the ejection orifices or fill the inks.

In the field of inkjet printers in recent years, there has been a demand for circulation-type liquid ejection apparatuses in order to output print products with high image quality. The liquid ejection heads mounted in the circulation-type liquid ejection apparatuses have liquid supply channels and liquid collection channels in their ejection orifice arrays. In this way, the liquids can be circulated through the pressure chambers corresponding to the ejection orifices. Such a configuration makes it possible to discharge bubbles in channels and prevent or reduce thickening of the liquids near the ejection orifices and inside the channels due to evaporation of the moisture from the ejection orifices during printing. In order to circulate the inks in a scan-type liquid ejection head, the liquid ejection head is equipped with multiple sub tanks each including a circulation pump inside a circulation unit.

The sub tanks are each connected to a liquid supply channel and a liquid collection channel provided inside a housing member in the liquid ejection head. Signals for driving the circulation pumps of the sub tanks are sent from a wiring substrate including the liquid ejection head. The wiring substrate needs elements for driving the pumps, and is equipped with connectors for electrically connecting to the multiple sub tanks and also electronic components that form a pump driving circuit, e.g., resistors, capacitors, inductors, diodes, transistors, and a control integrated circuit (IC). Also, such a wiring substrate is formed to have a multi-layer wiring configuration since it is necessary to add one layer for forming a driving circuit to a known wiring substrate, and in one embodiment, add another layer as a protection for an IC chip circuit. This increases the thickness of the wiring substrate used in the present disclosure and its size as well, thus making it heavy. If a liquid ejection head with a heavy wiring substrate is dropped with the wiring substrate facing down, tip portions of rivet portions fixing the wiring substrate may crack and the wiring substrate may get detached.

The liquid ejection head of the present disclosure employs a heat riveting method, a snap-fitting method, or the like to mechanically fix the housing member and wiring substrate of the liquid ejection head to each other, and additionally is provided with a bonding portion at an appropriate portion between the housing member and wiring substrate of the liquid ejection head. Such a simple configuration makes the liquid ejection head of the present disclosure a liquid ejection head having high reliability against drops of the liquid ejection head.

The present disclosure relates to a structure that improves the reliability of a liquid ejection head and a process for producing a liquid ejection head. In particular, the present disclosure provides a liquid ejection head having high reliability with a simple configuration which only involves further providing a bonding portion on the back surface of the wiring substrate of the liquid ejection head in the method of fixing the housing member and the wiring substrate of the liquid ejection head to each other.

In the present disclosure, the surface of the wiring substrate in which contact pads are present will be referred to as "first surface." In the description of the liquid ejection head of the present disclosure in this specification, the surface of the wiring substrate in which the contact pads are present (i.e., "first surface") will be referred to as "contact surface" or "substrate front surface (or simply "front surface"). In the present disclosure, the surface of the wiring substrate located on the opposite side from the first surface will be referred to as "second surface." In the description of the liquid ejection head of the present disclosure in this specification, the surface of the wiring substrate located on the opposite side from the first surface (i.e., "second surface") will be referred to as "the back surface behind the contact surface" or "substrate back surface (or simply "back surface"). Also, in the liquid ejection head of the present disclosure, the wiring substrate and the housing member are mechanically fixed to each other. In this specification, each portion at which this mechanical fixing is done will be referred to as "first fixing portion." In one embodiment, the first fixing portion provides fixing by a heat riveting method or a snap-fitting method. In the liquid ejection head of the present disclosure, the wiring substrate and the housing member are fixed to each other with an adhesive agent between the second surface of the wiring substrate and a bonding surface provided on the housing member. In the present disclosure, the portion at which this fixing with the adhesive agent is done will be referred to as "second fixing portion."

### First Embodiment

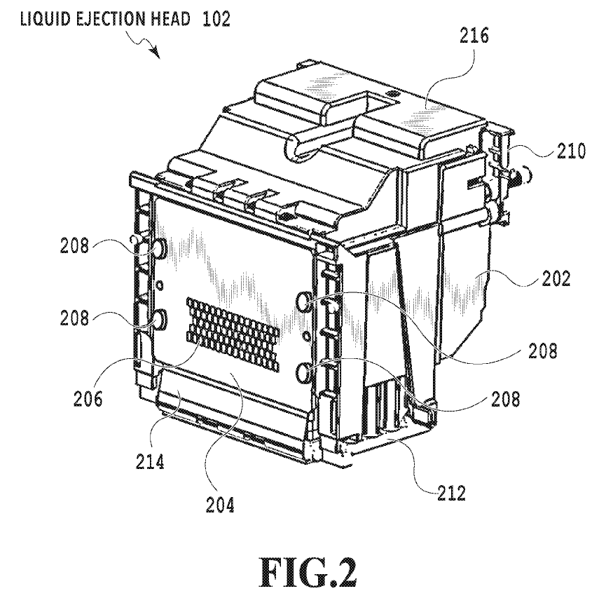

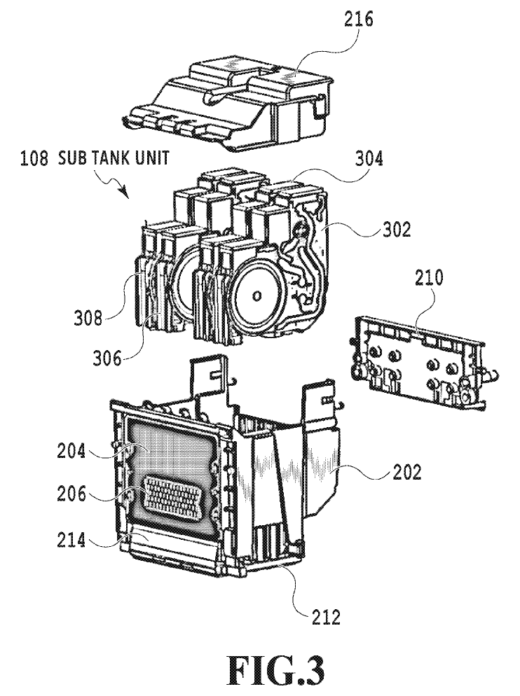

A first embodiment of the liquid ejection head of the present disclosure will be described using FIGS. 2 and 3.

FIG. 2 is a perspective view of a liquid ejection head 102. FIG. 3 is an exploded perspective view of the liquid ejection head 102.

As illustrated in FIGS. 2 and 3, the liquid ejection head 102 includes a housing member 202 and a wiring substrate 204. The wiring substrate 204 includes contact pads 206. The housing member 202 and the wiring substrate 204 include rivet portions 208 (at four positions in the example of FIG. 2) and are fixed to each other by these rivet portions. The liquid ejection head 102 includes a joint member 210, a liquid ejection module 212, a flexible substrate (flexible printed circuit (FPC)) 214, and a head cover 216. The liquid ejection head can include circulation units each including a circulation pump.

As illustrated in FIG. 3, the housing member 202 includes a sub tank unit 108, and the sub tank unit includes sub tanks 302, 304, 306, and 308. Though not illustrated in FIG. 3, the liquid ejection head can include circulation units each including a circulation pump. Note that the liquid ejection head of the present disclosure may be configured without circulation units each including a circulation pump. The housing member 202 is connected to the liquid ejection module 212 and supplies liquids from the sub tanks 302, 304, 306, and 308 to the liquid ejection module 212. The liquid ejection module 212 includes the flexible substrate (FPC) 214. The flexible substrate (FPC) 214 is connected to the wiring substrate 204. The wiring substrate 204 includes the contact pads 206 for electrically connecting to the carriage 106.

The joint member 210 is a member for establishing liquid connections to the carriage 106 and is screwed to the housing member 202. The head cover 216 is fixed to the top of the housing member 202 and protects the sub tanks 302, 304, 306, and 308 of the sub tank unit 108. The sub tanks 302, 304, 306, and 308 are connected to the housing member 202 and the joint member 210 and electrically connected to the wiring substrate 204 by cables.

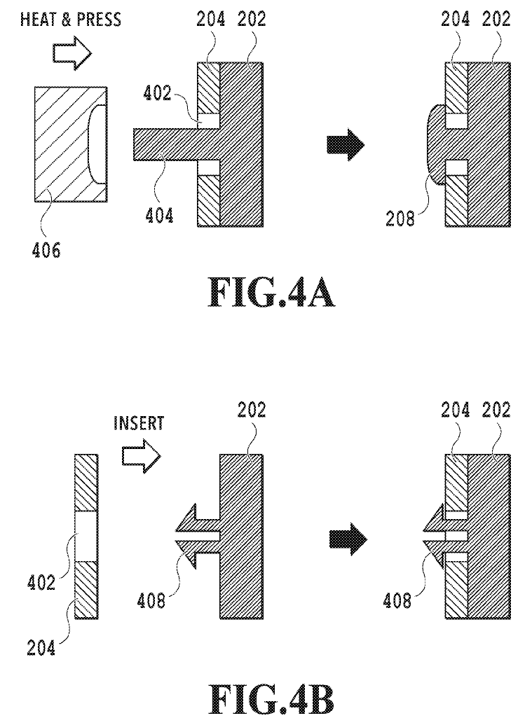

The rivet portions 208 of the liquid ejection head of the present disclosure and the connection between the wiring substrate 204 and the housing member 202 with the rivet portions will now be described with reference to FIGS. 4A and 4B, FIGS. 5A to 5C, FIGS. 6A and 6B, FIGS. 7A and 7B, and FIGS. 8A and 8B.

FIGS. 4A and 4B are schematic views illustrating how the wiring substrate 204 is fixed to the housing member 202. In the present disclosure, the method of fixing the wiring substrate 204 and the housing member 202 to each other is not particularly limited as long as it is a method that can be used to fix these members to each other. However, in one embodiment, a heat riveting method or a snap-fitting method can be used. In the following description, a heat riveting method and a snap-fitting method are employed as examples, but the present disclosure is not limited to these examples.

FIG. 4A illustrates the heat riveting method, and FIG. 4B illustrates the snap-fitting method. In the heat riveting method, protruding portions 404 of the housing member are inserted into through-holes 402 in the wiring substrate 204, and the protruding portion 404 of the housing member are heated and pressed with a heating tool 406. By doing this, a tip portion of each protruding portion of the housing member is melted to form an umbrella-shaped rivet portion 208 at the tip, and the wiring substrate 204 is fixed to the housing member 202. In the snap-fitting method, snap-fits 408 are inserted into the through-holes 402 in the wiring substrate 204. At this time, each snap-fit passes through the through-hole 402 while the protrusion at its tip is deformed inward. If the snap-fit 408 is thoroughly inserted, the tip of the snap-fit 408 returns to the original state, and the wiring substrate 204 and the housing member 202 are fixed each other. The following description of the present disclosure will be given based on the heat riveting method, but the snap-fitting method or a known fixing method, such as a press-fitting method, may be used instead. The procedures, conditions, and the like for these methods are known to those skilled in the art. Also, the following description will be given based on a case where the rivet portions 208 are disposed substantially at the four corners of the wiring substrate 204, but the positions of the rivet portions may be set as appropriate by those skilled in the art according to the strength required.

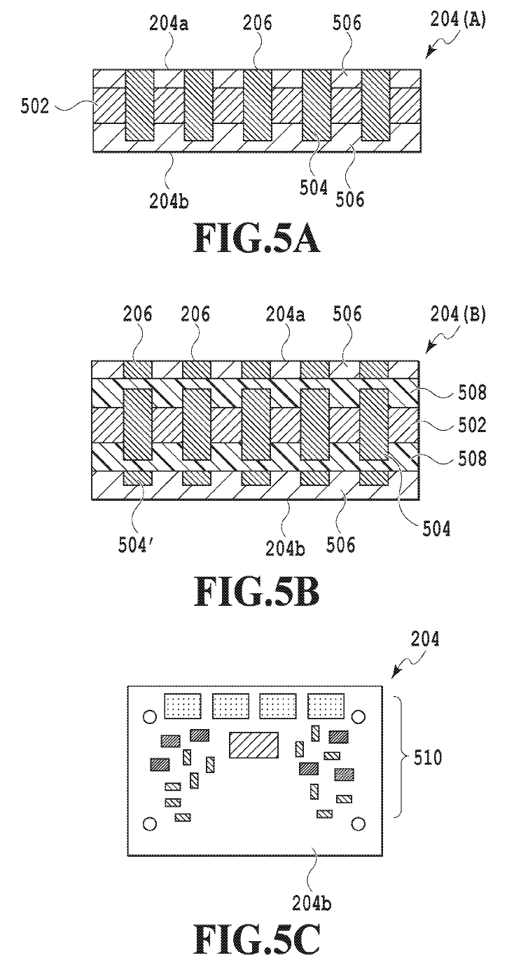

FIGS. 5A to 5C are schematic views illustrating cross sections of the wiring substrate 204 and mounted components. FIG. 5A illustrates a double-sided wiring substrate 204(A). FIG. 5B illustrates a multi-layer wiring substrate 204(B). Also, FIG. 5C illustrates various components mounted on the wiring substrate 204. More specifically, as illustrated in FIG. 5A, the double-sided wiring substrate 204(A) (in the present disclosure, the double-sided wiring substrate will be referred to also as "wiring substrate 204(A)") has a substrate front surface 204a and a substrate back surface 204b. The wiring substrate 204(A) includes an insulation layer 502, and metal wirings 504 are patterned in both surfaces of the wiring substrate 204(A) through this insulation layer 502. The both surfaces of the wiring substrate 204(A) are covered with a solder resist 506 except for the portions of the substrate front surface 204a (contact surface) side of the wiring substrate for the contact pads 206.

As illustrated in FIG. 5B, the multi-layer wiring substrate 204(B) (in the present disclosure, the multi-layer wiring substrate will be referred to also as "wiring substrate 204(B)") has a substrate front surface 204a and a substrate back surface 204b. The wiring substrate 204(B) has metal wirings 504 patterned in both surfaces of an insulation layer 502. Both surfaces of this insulation layer including the metal wirings 504 are covered with a pre-preg 508. Further, contact pads 206 and metal wirings 504' are patterned on the pre-preg. The both surfaces of the wiring substrate 204(B) are covered with a solder resist 506 except for the portions of the substrate front surface 204a side for the contact pads 206.

Next, FIG. 5C illustrates an example of a case where components are mounted on the substrate back surface 204b. The wiring substrate 204 needs many elements for driving the circulation pumps included in the circulation units of the sub tank unit. For example, as illustrated in FIG. 5C, the substrate back surface 204b includes connectors for electrically connecting to the sub tanks. In addition to these, electronic components 510 that form a pump driving circuit, e.g., resistors, capacitors, inductors, diodes, transistors, and a control IC, are mounted on the substrate back surface 204b.

It is also necessary to add one layer for forming a driving circuit on the above-described wiring substrate 204(A). In one embodiment, another layer may be further added for protecting an IC chip circuit. As described above, the liquid ejection head of the present disclosure includes a wiring substrate 204 with a multi-layer wiring configuration like the above-described wiring substrate 204(B). Thus, the wiring substrate 204 of the present disclosure is relatively large in size for a liquid ejection head. In a case of fixing such a wiring substrate 204 to the housing member 202 only by heat riveting, the strength of the rivet portions 208 for fixing the two members may be insufficient. In fact, with the liquid ejection head of the present disclosure, fixing only with the rivet portions 208 resulted in cracking of the bases of the rivet portions 208 in a drop test.

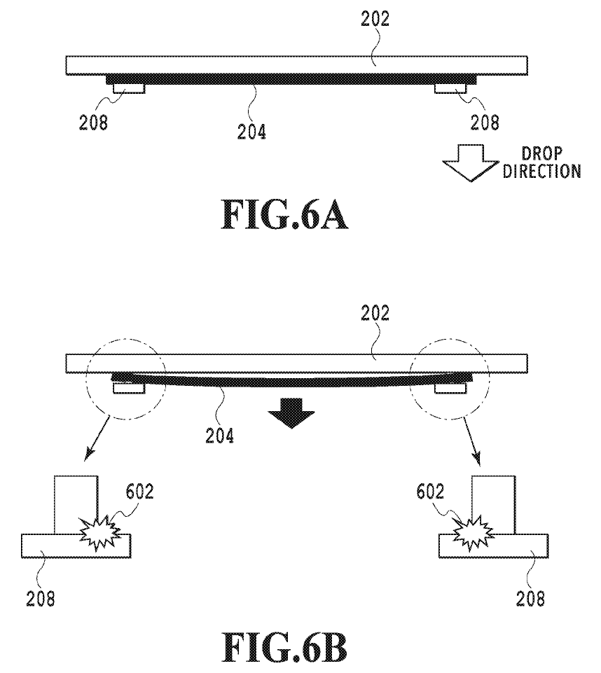

The state of the rivet portions 208 in a case where the liquid ejection head with the wiring substrate 204 and the housing member 202 fixed only with the rivet portions 208 is dropped will now be described with reference to FIGS. 6A and 6B. FIGS. 6A and 6B are schematic views illustrating this state.

A model analysis was performed on the above liquid ejection head by performing a drop simulation. The model analysis was performed by calculating the amount of deformation of each rivet pin and the stress at its broken portion. The calculation was performed using simulation software (LS-DYNA developed by ANSYS, Inc). From the simulation, the following were found. First, in a case where the liquid ejection head is dropped with the wiring substrate 204 facing down (FIG. 6A), an inertial force is exerted at the moment in a case where it hits the ground. As a result, the wiring substrate 204, whose central portion is not fixed, gets deformed at around its center in a direction away from the housing member 202 (FIG. 6B). It was found that this deformation causes stress concentration at bases 602 of the rivet portions and cracks tip portions of the rivet portions 208 (the portions formed by the heat riveting). For example, in a simulation with a drop height of 75 cm, the wiring substrate 204 was deformed by approximately 0.8 mm.

The cause of the above cracking was the insufficient strength of the rivet portions 208 against the stress exerted on the rivet portions 208 in a case where the wiring substrate 204 got deformed by the drop. A possible countermeasure against such cracking is to enlarge the rivet portions 208 to increase their strength. However, there is a limit to the size of the rivet portions 208 that can be formed by the heat riveting method, and the model analysis based on the above simulation indicated that a significant effect cannot be achieved through enlargement.

Also, another method may be to add a heat riveting position. However, it is difficult to add a rivet portion 208 to increase the number of fixing positions since there are multiple contact pads 206 for electrically connecting to the carriage 106 at around the center of the wiring substrate 204. Also, there is a method in which an adhesive agent is applied to the entirety of the back surface of the wiring substrate 204 (the surface to be bonded to the housing member), and the housing member and the wiring substrate 204 are fixed to each other with the adhesive agent. In this method, however, the adhesive agent must be applied to the entire back surface of the wiring substrate 204, and it takes time before the large amount of the adhesive agent cures. For this reason, it is not realistic to fix the entire back surface of the wiring substrate 204 to the housing member with an adhesive agent.

The present disclosure implements a liquid ejection head having high reliability with a simple configuration by providing a bonding portion at an appropriate portion between the housing member and wiring substrate of the liquid ejection head. The liquid ejection head of the present disclosure provided with the bonding portion will be described below in more detail.

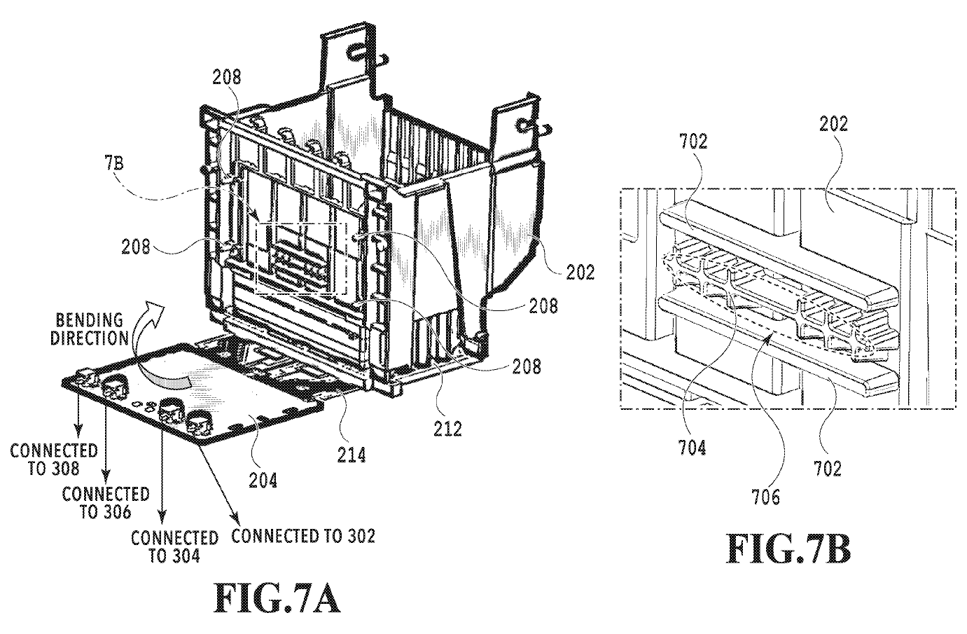

FIG. 7 is a perspective view illustrating a state before the wiring substrate 204 is fixed to the housing member 202. Also, the portion indicated by the dashed line in FIG. 7 is an enlarged view illustrating the bonding portion at which the housing member 202 is bonded to the wiring substrate 204. On the housing member 202, wiring substrate receiving surfaces 702 and a bonding surface 704 are provided adjacent to each other. In the present disclosure, the height of the bonding surface 704 (the height of the bonding surface from the housing member 202 toward the wiring substrate 204) may be lower than the height of the wiring substrate receiving surfaces 702. The difference in height between the wiring substrate receiving surfaces 702 and the bonding surface 704 is desirably approximately 0.1 mm to 1 mm. An adhesive agent 706 can be applied to the bonding surface.

Because of the above-mentioned height difference between the wiring substrate receiving surfaces 702 and the bonding surface 704, a clearance is formed between the back surface 204b of the wiring substrate and the bonding surface 704. The adhesive agent 706 is filled in this clearance. This can prevent the wiring substrate 204 from bulging in the state where the housing member 202 and the wiring substrate 204 are fixed to each other.

The adhesive agent 706 can be used without particular limitations as long as it is a cold setting adhesive agent. A cold setting silicone-based adhesive agent can be used. In one embodiment, the adhesive agent 706 may be a silicone-based adhesive agent. This is because a silicone-based adhesive agent is easily to handle, allows the housing member 202 and the wiring substrate 204 to be detached from each other relatively easily in a case of disassembling the liquid ejection head, and is desirable from the environmental perspective. The cold setting adhesive agent cures within several hours of being left as is after being applied. Thus, by leaving the adhesive agent for several hours, the bonding surface 704 and a predetermined portion of the back surface 204b of the wiring substrate (the portion facing the bonding surface of the housing member) get fixed to each other.

The region on the housing member 202 where the wiring substrate receiving surfaces 702 and the bonding surface 704 are provided (in this specification, referred to also as "the bonding region on the housing member") will now be described. The bonding region on the housing member is a region within which a high bonding effect can be achieved for the bonding between the housing member 202 and the wiring substrate 204. For example, a rectangular region defined by connecting the protruding portions 404, or rivet pins, of the housing member corresponding to the rivet portions is desirable as the bonding region on the housing member. A bonding effect can be achieved within this region. Note that the bonding effect weakens the farther it gets toward the outer side of this rectangular region. In one embodiment, the bonding region on the housing member may be a region corresponding to the region on the wiring substrate where the contact pads 206 are provided. The portion at the intersection of two diagonal lines each connecting diagonally opposite protruding portions 404, or rivet pins, of the housing member corresponding to rivet portions is the most desirable bonding region on the housing member. A region as above can effectively prevent or reduce the deformation of the wiring substrate 204 in a case where the liquid ejection head is dropped. Further, a region as above can also reliably fix the region of the contact pads 206, which are important parts in the mounting of the liquid ejection head to the main body of a printer. The area of the bonding region on the housing member can be approximately 15 square millimeters. The ratio of this area to the area of the wiring substrate 204 is approximately 0.5 percent.

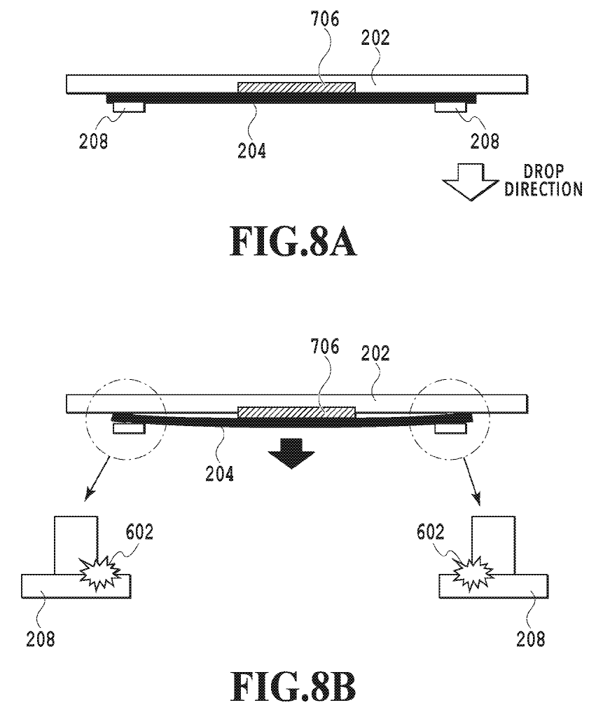

Next, the liquid ejection head provided with the above-described bonding surface will be further described with reference to FIGS. 8A and 8B. FIGS. 8A and 8B are schematic views illustrating the state of the rivet portions of the liquid ejection head of the present disclosure in a case where it is dropped. A model analysis was performed on the liquid ejection head of the present disclosure through a drop simulation. The model analysis was performed in a similar manner to that described earlier for the liquid ejection head described with reference to FIGS. 6A and 6B. That is, the model analysis was performed by calculating the amount of deformation of each rivet pin and the stress at its broken portion. The calculation was performed using simulation software (LS-DYNA developed by ANSYS, Inc). From the simulation, the following were found. First, in a case where the liquid ejection head is dropped with the wiring substrate 204 facing down (FIG. 8A), an inertial force is exerted at the moment when it hits the ground. In the liquid ejection head of the present disclosure, a central portion of the wiring substrate is fixed by the adhesive agent 706, so that the wiring substrate 204 hardly gets deformed (FIG. 8B). Thus, the liquid ejection head of the present disclosure can prevent or reduce stress concentration at the bases 602 of the rivet portions. From the simulation, it was found that cracking of the tip portions of the rivet portions 208 (the portions formed by the heat riveting) can be prevented. For example, in a simulation with a drop height of 75 cm, the wiring substrate 204 was deformed by 0.1 mm or less.

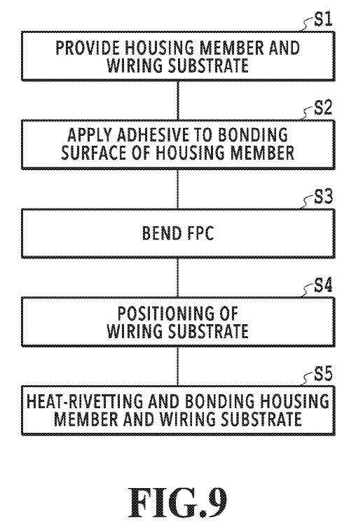

Next, a process for producing the liquid ejection head of the present disclosure will be described with reference to FIG. 9. The liquid ejection head of the present disclosure has the above-described structure. In particular, in the liquid ejection head of the present disclosure, the wiring substrate 204 is mechanically fixed to the housing member 202 at the rivet portions 208 (first fixing portions). Moreover, the back surface 204b of the wiring substrate 204 (second surface), which is located on the opposite side from the surface of the wiring substrate where the contact pads are provided (first surface), is fixed to the bonding surface 704 of the housing member (second fixing portion) with an adhesive agent.

First, the members of the liquid ejection head of the present disclosure, in particular the housing member 202 and the wiring substrate 204, are provided (S1 in FIG. 9). The members of the liquid ejection head of the present disclosure can be obtained through a known procedure. In particular, as illustrated in FIG. 7, the housing member has the wiring substrate receiving surfaces 702 and the bonding surface 704 at around the center of the housing member. The housing member may be prepared such that such structural portions are formed. As the preparation method, a method known to those skilled in the art can be used.

Next, the adhesive agent 706 is applied to the bonding surface 704 of the housing member (S2 in FIG. 9). The adhesive agent 706 can be applied directly to the bonding surface 704. Alternatively, the adhesive agent 706 can be applied to the back surface 204b of the wiring substrate at a position that coincides with the bonding surface 704 in the state where the wiring substrate 204 is fixed to the housing member 202. The adhesive agent 706 can be applied using a dispenser or the like.

Next, the flexible substrate (FPC) 214 included in the liquid ejection module 212 is bent at 90° in the bending direction along the arrow illustrated in FIG. 7 (S3 in FIG. 9). Thereafter, the through-holes 402 substantially at the four corners of the wiring substrate 204 are fitted to the protruding portions 404, or rivet pins, at four positions on the housing member 202 to position the wiring substrate (S4 in FIG. 9). Then, the tips of the protruding portions 404, or rivet pins, are melted with heat to mechanically fix the wiring substrate 204 to the housing member. The adhesive agent 706 is a cold setting type, and cures within several hours of being left as is. As a result, the back surface 204b of the wiring substrate and the bonding surface 704 are fixed to each other by the adhesive agent (S5 in FIG. 9). In the state where the back surface 204b of the wiring substrate abuts the wiring substrate receiving surfaces 702, a clearance is present between the back surface 204b of the wiring substrate and the bonding surface 704. Thus, the adhesive agent 706 is filled in this clearance and keeps the wiring substrate 204 from bulging.

The connectors mounted on the wiring substrate 204 are connected respectively to the sub tanks 302, 304, 306, and 308 by cables (see FIG. 7). The liquid ejection head of the present disclosure is produced in this manner.

### Second Embodiment

A second embodiment represents an example in which the adhesive agent on the bonding surface in the first embodiment is applied to the back surface of the wiring substrate. In the description of the first embodiment, an example in which an adhesive agent is applied to a bonding surface on the housing member has been described, but the adhesive agent may be applied to the wiring substrate. In this case, the adhesive agent 706 is applied to the back surface 204b of the wiring substrate such that the position on the wiring substrate 204 to which the adhesive agent is applied and the position of the bonding surface 704 coincide with each other in the state where the wiring substrate 204 is fixed to the housing member 202.

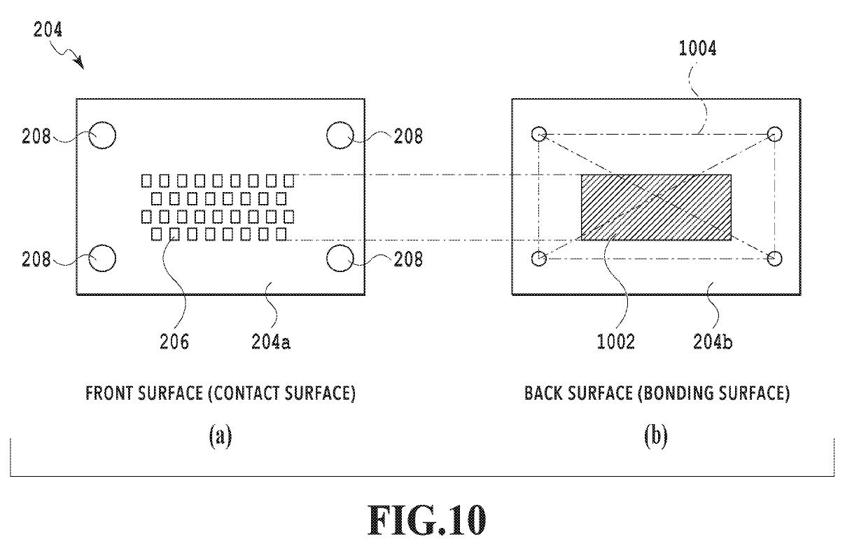

FIG. 10 is a schematic view illustrating the contact surface and back surface of the wiring substrate 204. A bonding region on the back surface 204b of the wiring substrate will now be described using these figures. As illustrated in FIG. 10 (a), in the present disclosure, the contact pads 206 are provided in the front surface 204a of the wiring substrate. In the present embodiment, a region 1002 on the back surface 204b of the wiring substrate corresponding to these contact pads 206 is a region within which a high bonding effect can be achieved with an adhesive agent. In the second embodiment, in one embodiment, this region 1002 behind the contact pads can be a region to apply the adhesive agent. In this region, the intersection of two diagonal lines each connecting diagonally opposite through-holes in the wiring substrate corresponding to rivet portions is particularly a desirable position as the position to apply the adhesive agent. A region as above can effectively prevent or reduce the deformation of the wiring substrate 204 in the case where the liquid ejection head is dropped. Further, a region as above can reliably fix the region of the contact pads 206, which are important parts for the mounting of the liquid ejection head to the main body of a printer.

Further, a region 1004 illustrated in FIG. 10 (b) is a rectangular region defined by connecting the through-holes corresponding to the rivet portions. A sufficient bonding effect can be achieved within this region as well. Note that the bonding effect within this region 1004 weakens the farther it gets toward the outer side from its center. The area of bonding of the wiring substrate 204 is approximately 15 square millimeters. Having such an area can reliably fix the housing member and the wiring substrate to each other. The ratio of the bonding surface to the wiring substrate 204 may be approximately 0.5 percent.

The structure of the liquid ejection head in the second embodiment and the process for producing it are the same as those in the first embodiment except that the adhesive agent is applied to the wiring substrate 204.

Note that the adhesive agent 706 may be applied using a combination of application methods as described in the first and second embodiments, or applied to a position on the back surface of the wiring substrate as described above or to the bonding surface 704 of the housing member described in the first embodiment.

### Third Embodiment

A third embodiment represents examples of the shape of the bonding surface 704.

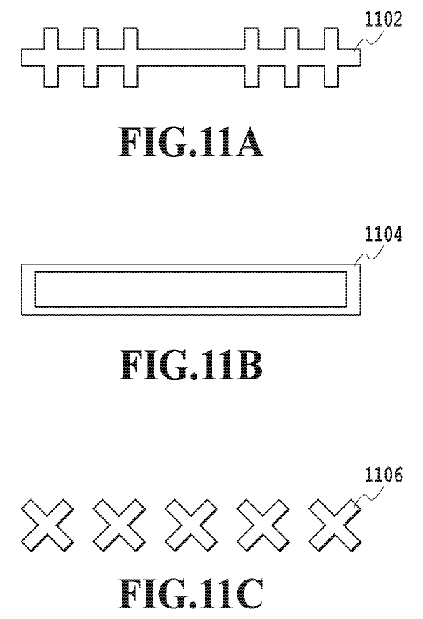

FIGS. 11A to 11C are schematic views illustrating examples of the shape of the bonding surface 704. The shapes of the bonding surface 704 illustrated in FIGS. 11A to 11C are shape examples that can be employed in the present disclosure. The shapes illustrated in FIGS. 11A to 11C are examples, and shapes of the bonding surface 704 that can be used in the present disclosure are not particularly limited as long as the housing member 202 and the wiring substrate 204 can be bonded to each other. In one embodiment, the shape illustrated in FIG. 11A can be a desirable shape of the bonding surface. FIGS. 11B and 11C illustrating shapes of the bonding surface are modifications of a bonding surface 1102. Each of these is a shape taking into consideration the formability, the cracking in the case where the liquid ejection head is dropped, and so on, and can provide an effective bonding area in a space-saving manner. Further, these shapes can be expected to exhibit an anchor effect since the adhesive agent can flow into the corners on the ribs. In the present disclosure, these bonding surfaces can be further subjected to graining. The graining can roughen the bonding surface, which can in turn bring about a further anchor effect.

In the present disclosure, the number of branches or crosses in the above shapes is not particularly limited, but can be 3 or more and 10 or less. In one embodiment, the number of branches or crosses in the above shapes may be 3 or more and 5 or less.

As described above, in the liquid ejection head of the present disclosure, a portion of the back surface of the wiring substrate around its center is fixed to the housing member with an adhesive agent. In this way, a wiring substrate of a relatively large size can be reliably fixed to the housing member. Even if the liquid ejection head of the present disclosure is dropped with its surface with the wiring substrate facing down, deformation of the wiring substrate can be prevented or reduced, so that the rivet portions hardly receive a stress. This can prevent breakage of the rivet portions. Hence, a liquid ejection head having high reliability against drops can be provided by an inexpensive and simple method that involves fixing with heat riveting and an adhesive agent.

### EXAMPLES

### Example 1

A drop test was carried out on the liquid ejection head of the present disclosure to evaluate the effect of the present disclosure. The liquid ejection head in the present example is a liquid ejection head in which the bonding surface 704 of a housing member roughened with a file and a wiring substrate are attached to each other with an adhesive agent 706. As the adhesive agent, a cold setting silicone-based adhesive agent was used. A drop test was carried out on this liquid ejection head. As for the conditions of the drop test, the liquid ejection head of the present disclosure was dropped onto concrete with the surface with the wiring substrate facing down from a height of 150 cm at a temperature of 5°C, and evaluated based on whether any of the rivet heads of the rivet portions cracked and scattered. The liquid ejection head was dropped twice, and the bases of the rivet portions did not crack in both drops.

### Comparative Example 1

A drop test was carried out on a liquid ejection head in which a housing member and a wiring substrate were attached to each other only by heat riveting. The drop test was the same as that in Example 1 except that no adhesive agent was used and the drop height was 75 cm. The result of the drop test was such that the rivet heads of the rivet portions cracked and scattered in the second drop.

### Example 2

The present example describes the result of an evaluation of the liquid ejection head of the present disclosure and a liquid ejection head in which a housing member and a wiring substrate were fixed to each other only by heat riveting by a simulation.

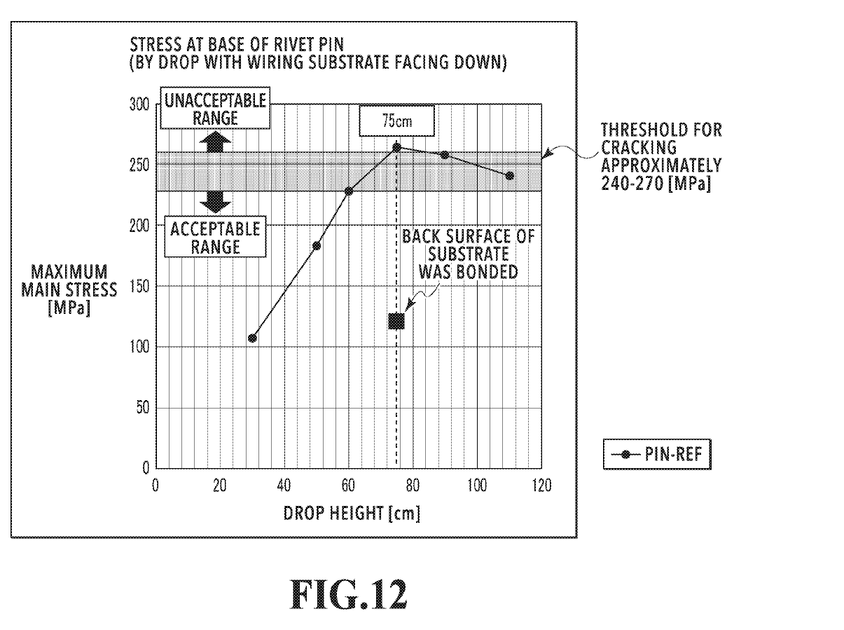

A model analysis was performed on the liquid ejection head in which the housing member 202 and the wiring substrate 204 were fixed to each other only with the rivet portions 208 by performing a drop simulation. FIG. 12 is a graph illustrating the result of a simulation on the stress exerted on the base of each rivet portion 208 of this liquid ejection head (PIN-REF in FIG. 12). The simulation was performed by calculating the amount of deformation of the rivet pin and the stress at its broken portion. The calculation was performed using simulation software (LS-DYNA developed by ANSYS, Inc). As illustrated in FIG. 12, the larger the drop height, the higher the stress will be exerted on the bases of the rivet portions 208. The stress exerted on the base of each rivet portion 208 in a drop from a height of 75 cm was 267 [MPa]. Also, the stress exerted on the base of each rivet portion 208 in a drop from a height of 60 cm was 230 [MPa]. Combining these results and the test results in the above-described examples, the threshold for the cracking of a rivet portion 208 was determined to be approximately 240 [MPa] or more and 270 [MPa] or less. In contrast, the result of the simulation on the stress exerted at the base of a rivet portion 208 in the case where the back surface 204b of the wiring substrate was fixed with an adhesive agent was 129 [MPa] (the position of "BACK SURFACE OF SUBSTRATE WAS BONDED" (black square) in FIG. 12). An effect was confirmed from the numerical values in the simulation with the liquid ejection head of the present disclosure, in which the housing member 202 and the wiring substrate 204 were fixed by heat riveting and an adhesive agent.

As described above, from the actual drop test and the evaluation through the simulation, the liquid ejection head of the present disclosure was found to be capable of preventing or reduce deformation of its wiring substrate and preventing breakage of the rivet portions even if the liquid ejection head is dropped with its surface with the wiring substrate facing down.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to provide a liquid ejection head capable of preventing cracking of the tips of rivet portions fixing a wiring substrate even if the liquid ejection head is dropped with the wiring substrate facing down.

This application claims the benefit of Japanese Patent Application No. 2024-213839, filed December 6, 2024, which is hereby incorporated by reference herein in its entirety.

What is claimed is:

1. A liquid ejection head comprising:
a housing member comprising a liquid ejection module for ejecting a liquid and a channel for supplying the liquid to the liquid ejection module;
a wiring substrate comprising, at a first surface, a contact pad for electrically connecting to a liquid ejection apparatus;
a first fixing portion, at the fixing portion, the wiring substrate and the housing member being mechanically fixed to each other; and
a second fixing portion, the second fixing portion being provided between a second surface of the wiring substrate located on an opposite side from the first surface and a bonding surface provided on the housing member and at the second fixing portion, the second surface and the bonding surface are fixed to each other with an adhesive agent.

2. The liquid ejection head according to claim 1, wherein the first fixing portion is disposed at four corners of the wiring substrate.

3. The liquid ejection head according to claim 2, wherein the bonding surface is provided within a region enclosed by the first fixing portions disposed at the four corners of the wiring substrate.

4. The liquid ejection head according to claim 2, wherein the bonding surface is present at a position comprising an intersection of lines each connecting diagonally opposite ones of the first fixing portions disposed at the four corners of the wiring substrate.

5. The liquid ejection head according to claim 1, wherein the mechanical fixing at the first fixing portion is heat riveting.

6. The liquid ejection head according to claim 1, wherein the bonding surface has a height lower than a height of a wiring substrate receiving surface provided on the wiring substrate.

7. The liquid ejection head according to claim 1, wherein the bonding surface has been subjected to graining.

8. The liquid ejection head according to claim 1, further comprising a circulation unit, the circulation unit circulating the liquid between the circulation unit and the liquid ejection module.

9. The liquid ejection head according to claim 8, wherein the circulation unit comprises a pump.

10. A process for producing a liquid ejection head comprising
a housing member comprising a liquid ejection module for ejecting a liquid and a channel for supplying the liquid to the liquid ejection module, and
a wiring substrate comprising, at a first surface, a contact pad for electrically connecting to a liquid ejection apparatus,
the process comprising:
mechanically fixing the wiring substrate and the housing member at a first fixing portion; and
fixing a second surface of the wiring substrate located on an opposite side from the first surface and a bonding surface provided on the housing member to each other at a second fixing portion with an adhesive agent.

11. The process for producing a liquid ejection head according to claim 10, wherein the adhesive agent is applied to the bonding surface provided on the housing member, followed by mechanically fixing the wiring substrate and the housing member to each other at a plurality of the first fixing portions provided at four corners of the wiring substrate and the housing member and fixing the wiring substrate and the housing member to each other at the second fixing portion with the adhesive agent.

12. The process for producing a liquid ejection head according to claim 10, wherein the adhesive agent is applied to the second surface of the wiring substrate at a position coinciding with the bonding surface provided on the housing member, followed by mechanically fixing the wiring substrate and the housing member to each other at a plurality of the first fixing portions provided at four corners of the wiring substrate and the housing member and fixing the wiring substrate and the housing member to each other at the second fixing portion with the adhesive agent.

13. The process for producing a liquid ejection head according to claim 10, wherein the adhesive agent is a cold setting type.
